(19) United States
(12) Patent Application Publication
(10) Pub. No.: US 2018/0141222 A1
(43) Pub. Date: May 24, 2018

(54) SCISSORS FOR HAIRDRESSING

(71) Applicant: HIKARI CORPORATION, Itabashi-ku, Tokyo (JP)

(72) Inventor: Kazuyoshi TAKAHASHI, Itabashi-ku (JP)

(73) Assignee: HIKARI CORPORATION, Itabashi-ku, Tokyo (JP)

(21) Appl. No.: 15/562,404

(22) PCT Filed: Apr. 8, 2015
(86) PCT No.: PCT/JP2015/061026

§ 371 Date: Sep. 27, 2017

(51) Int. Cl. B26B 13/20; B25G 1/10

(52) U.S. Cl. CPC B26B 13/20; B25G 1/102

(57) ABSTRACT

The purpose of the present invention is to reduce stress on the ring finger during use of a pair of scissors, and to reduce the burden for hairdressers. A moving blade being continuous with a thumb ring via a handle portion comprises a first scissor half, while a stationary blade being continuous with a ring-finger ring via a handle portion comprises a second scissor half. The first scissor half and the second scissor half are pivotably coupled at a pivot point. The second scissor half is formed by a scissor half blade side portion and a scissor half ring side portion being coupled by a coupling portion, which includes a pivot mechanism and an elastic mechanism. The scissor half ring side portion is pivotable about a coupling axis with respect to the scissor half blade side portion. The elastic mechanism acts so as to turn back (oppose) the pivotal movement.

### TECHNICAL FIELD

The present invention relates to scissors for haircutting or hairdressing.

### BACKGROUND ART

A structure and an effect of scissors (conventional art) commercially used by barbers and hairdressers (hair experts) will be briefly described below. A first scissor half including a moving blade and a thumb ring is pivotably coupled to a second scissor half including a stationary blade, a ring finger ring, and a little finger rest via a pivot. When cutting hair, a thumb is inserted into a thumb ring, a ring finger is inserted into a ring finger ring, an index finger and a middle finger are positioned to support a handle part of the second scissor half, and a little finger is positioned so as to be hooked by a little finger rest. When a thumb pad side presses the thumb ring, the moving blade pivots with respect to the stationary blade to cut hair positioned between the stationary blade and the moving blade.

At the time, a contact between the ring finger and the ring finger ring enables to hold an attitude of the scissors. A ring contact portion where the ring finger contacts receives a load. A long time use of scissors will callus or deform the ring finger. In other words, such movement gives a burden to a hair expert without knowing.

Incidentally, haircutting for one person requires about 700 opening/closing movements. It takes about 20 minutes. Assuming that a hairdresser performs haircutting for 10 people per a day, the hairdresser results in performing about 7000 opening/closing movements. It takes about 200 minutes per a day. Assuming that the hairdresser works for 240 days in a year, the hairdresser results in performing about 1,680,000 opening/closing movements. It takes about 800 hours. Assuming that the hairdresser continues to work for 20 years, the hairdresser results in performing beyond 30,000,000 opening/closing movements. It takes about 16,000 hours. As a result, almost all the hair experts are adversely influenced by a stress on the ring finger.

One of the occupational diseases which barbers or hairdressers are suffered from is tenosynovitis on fingers or a wrist. The stress on the ring finger may be a cause of the tenosynovitis of the fingers. Further, the stress on the ring finger may be transmitted to the wrist to be an indirect cause of the tenosynovitis of the wrist.

In addition to the above stress, when closing the scissors, the thumb ring impacts the ring finger ring. A shock of the impact may be a cause of the tenosynovitis of the fingers or the wrist.

Specially, a novel cutting technique is developed in these days. The technique requires an unnatural posture such as excessive flex of the wrist. Such posture invites more risk of the tenosynovitis.

In order to prevent the tenosynovitis, for example, the conventional art disclosed in Patent Literature 1 is proposed. In Patent Literature 1, a handle part of the scissors is partially formed into a hollow portion, the portion being filled with a viscoelastic substance and sealed. Owing to excellent shock absorbing function and vibration absorbing function of the viscoelastic substance, the shock suffered from the closing movement of the scissors can be reduced.

### CITATION LIST

### Patent Literature

[PATENT LITERATURE 1] WO2006/022368

### SUMMARY OF INVENTION

### Technical Problem

The conventional art disclosed in Patent Literature 1, however, cannot reduce the stress specifically applied to the ring finger.

Even if the shock suffered from the closing movement of the scissors can be partially reduced, the effect is limitative (not sufficient). In other words, this will not be a drastic measure for reducing the burden on the hair expert.

The present invention was made to solve the above described problem. A purpose of the present invention is to provide scissors capable of reducing the stress on the ring finger, resulting in reducing the burden on the hairdresser.

### Solution to Problem

The inventor of the present application has conducted intensive studies on the cause of the stress on the ring finger. As described above, haircutting is performed such that a thumb is inserted into a thumb ring, a ring finger is inserted into a ring finger ring, and a thumb pad side presses the thumb ring, thereby causing a moving blade to pivot with respect to a stationary blade and allowing the hair between the stationary blade and the moving blade to be cut. At the time, because of a contact between the ring finger and the ring finger ring, an attitude of scissors (specifically, stationary blade) can be held.

Incidentally, in the conventional art, constant traces are made by the thumb ring and the ring finger ring when opening/closing the scissors. The hair expert controls the movement of his fingers so as to accord with the traces of the two rings. As a result, a large load is applied to a ring contact portion where the ring finger contacts.

As a result of keen studies for solving the above described problem focusing on the above described cause, the inventor of the present application accomplished the present invention.

The present invention for solving the above described problem is directed to scissors comprising:

a first scissor half comprising a blade part and a thumb ring; and

a second scissor half comprising a blade part and a ring finger ring;

wherein the first scissor half and the second scissor half are pivotably coupled together via a pivot.

The second scissor half is formed such that a second scissor half blade side part and a second scissor half ring side part are coupled together via a coupling part. The second scissor half blade side part and the second scissor half ring side part are coupled together so as to be pivotable about a coupling axis.

The coupling part is provided with an elastic mechanism for turning back the pivotal movement.

Pivotal movement of the second scissor half ring side part can reduce the stress on the ring finger and the shock when closing the scissors. Further, the pivotal movement allows bending of the four fingers while keeping the attitude of the stationary blade when closing the scissors.

Because a reaction force produced by the elastic mechanism acts to oppose the pivotal movement, the pivotal movement contrary to the intention of the user can be controlled. Further, the reaction force acts so as to apply a biasing force during the closing movement of the scissors.

With the structure, the stress on the ring finger can be reduced and thereby the burden on the hairdresser can be reduced.

In the present invention, preferably, the elastic mechanism comprises a torsion spring.

In the present invention, preferably, the pivotal movement is performed such that the second scissor half blade side part pivots in a rotation direction of the four fingers with respect to the second scissor half ring side part.

The coupling part is provided with a pivotal movement restricting mechanism for restricting the pivotal movement beyond a predetermined angle.

In the present invention, preferably, the coupling part is provided with a connection retaining mechanism for retaining coupling connection while allowing pivotal movement.

In the present invention, preferably, a finger resting and hooking part for hooking an index finger or/and a middle finger is provided at a position toward a scissor tip end side from the ring finger ring of the second scissor half ring side part.

In the present invention, preferably, a hit point is provided on a position toward a pivot side from the coupling part of a handle part of the first scissor half or the second scissor half.

The present invention for solving the above described problem is directed to scissors comprising:

a first scissor half comprising a blade part and a thumb ring; and

a second scissor half comprising a blade part and a ring finger ring;

wherein the first scissor half and the second scissor half are pivotably coupled via a pivot.

The present invention comprises:

a coupling part for coupling a second scissor half blade side part and a second scissor half ring side part in one piece so as to form the second scissor half;

a pivot mechanism for causing the second scissor half ring side part to pivot about a coupling axis of the coupling part with respect to the second scissor half blade side part; and

an elastic mechanism that opposes to the pivotal movement.

### Advantageous Effect of Invention

According to the scissors of the present invention, the stress on the ring finger can be reduced. As a result, the burden on the hairdresser can be reduced.

### BRIEF DESCRIPTION OF DRAWINGS

FIG. 1 schematically illustrates a structure of scissors according to the present invention.

FIG. 2 schematically illustrates another structure of scissors according to the present invention.

FIG. 3 illustrates a detailed structure of a coupling part.

FIG. 4 illustrates another detailed structure of the coupling part.

FIG. 5 illustrates further another detailed structure of the coupling part.

FIG. 6 is scissors according to the conventional art.

FIG. 7 illustrates a haircutting operation according to the conventional art.

FIG. 8 illustrates a haircutting operation according to a present embodiment.

FIG. 9 illustrates another haircutting operation according to the present embodiment.

FIG. 10 illustrates detailed haircutting operation according to the present embodiment.

FIG. 11 is a modification example.

FIG. 12 is another modification example.

### DESCRIPTION OF EMBODIMENTS

### First Embodiment

### Structure

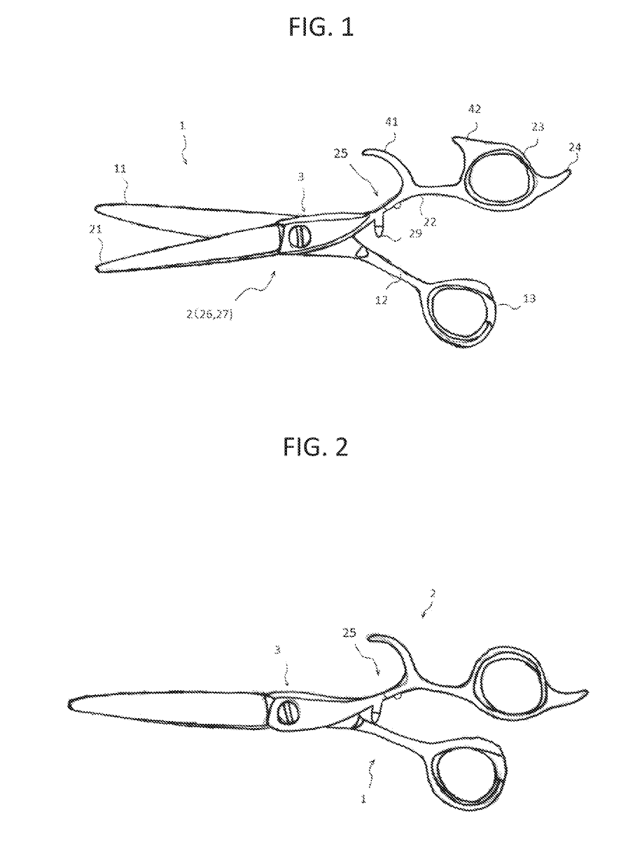

FIG. 1 and FIG. 2 schematically illustrates structures of scissors according to the present embodiments.

A moving blade 11 is continuous with a thumb ring 13 via a handle part 12 to form a scissor half 1. A stationary blade 21 is continuous with a ring finger ring 23 via a handle part 22 to form a scissor half 2. A little finger hook 24 extends from the ring finger ring 23. The scissor half 1 and the scissor half 2 are pivotably coupled via a pivot 3. When a thumb pad side presses the thumb ring 13, the moving blade 11 pivots with respect to the stationary blade 21 to cut the hair positioned between the stationary blade 21 and the moving blade 11. Hereinabove, a basic structure of the scissors is described.

In the present embodiment, a coupling part 25 is located midway in the handle part 22. More specifically, the scissor half 2 is formed such that a scissor half blade side part 26 and a scissor half ring side part 27 are coupled via the coupling part 25. A central axis of the handle part 22 is a coupling axis.

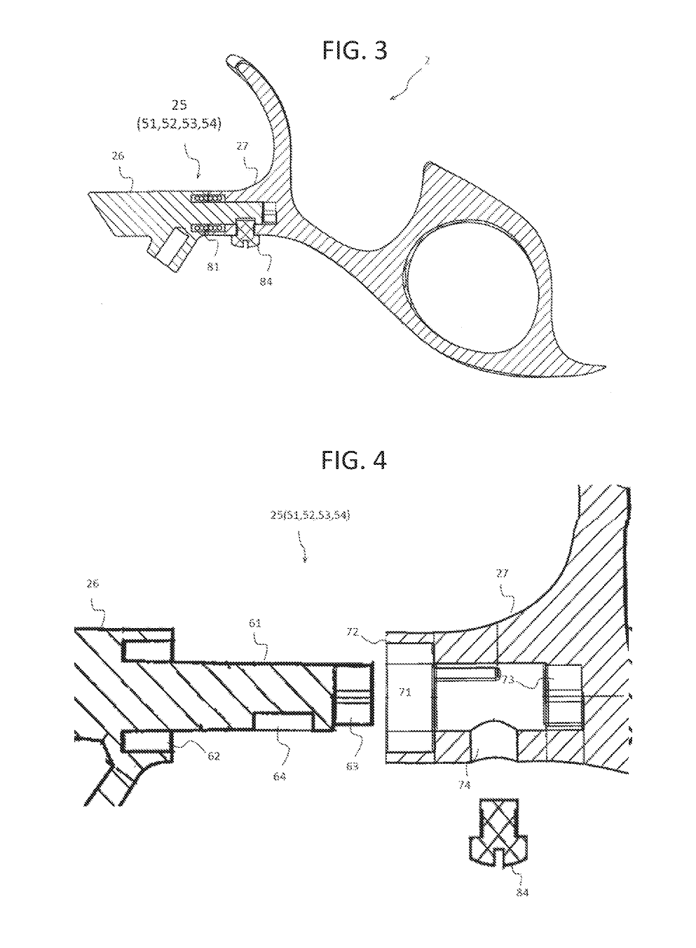

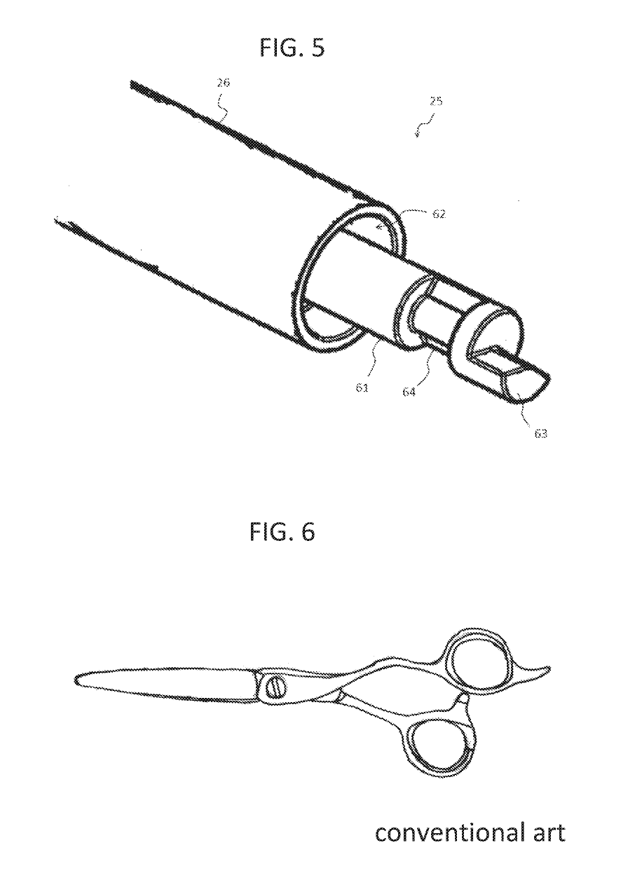

FIG. 3 to FIG. 5 illustrates a detailed structure of the coupling part 25. The coupling part 25 includes a pivot mechanism 51, an elastic mechanism 52, a pivotal movement restricting mechanism 53, and a connection retaining mechanism 54.

The scissor half ring side part 27 is pivotable about the coupling axis with respect to the scissor half blade side part 26.

An axis part 61 having a diameter one size smaller than that of the handle part 22 extends at an end portion of the scissor half blade side part 26. A groove is formed on a root of the axis part 61 so as to encircle the axis part 61, thereby forming a torsion spring insertion part 62.

A fan-shaped member is provided on an end surface of the axis part 61 to form a pivotal movement restricting part 63. A groove is provided on a peripheral surface of the axis part 61 in a circumferential direction, thereby forming a connection retaining groove 64.

An end portion of the scissor half ring side part 27 is provided with a hole capable of receiving the axis part 61, thereby forming a bearing part 71. An entrance of the bearing part 71 is formed to have a diameter one size lager than that of a bearing hole, thereby forming a torsion spring insertion part 72.

A pivotal movement allowable part 73 is provided in a depth position of the bearing part 71. The scissor half ring side part 27 is provided with a screw hole 74 that allows communication with the bearing part 71 from the outer surface.

The pivot mechanism 51 will be described below. The pivot mechanism 51 is formed by the axis part 61 being inserted into the bearing part 71. As a result, the scissor half ring side part 27 becomes pivotable about the coupling axis with respect to the scissor half blade side part 26.

The elastic mechanism 52 will be described below. The torsion spring insertion part 62 and the torsion spring insertion part 72 are positioned facing to each other and form a space together. A torsion spring 82 is interposed around the axis part 61 within a space formed by the torsion spring insertion parts 62 and 72. As a result, the elastic mechanism 52 is formed.

The elastic mechanism 52 acts so as to turn back the pivotal movement caused by the pivot mechanism 51 (described below in detail).

The pivotal movement restricting mechanism 53 will be described below. While the axis part 61 is inserted into the bearing part 71, the pivotal movement restricting part 63 mates with the pivotal movement allowable part 73. The fan-shaped member as the pivotal movement restricting part 63 includes a first locking face and a second locking face. On the other hand, the pivotal movement allowable part 73 is a fan-shaped space having an angle larger than that of the fan shape of the pivotal movement restricting part 63 and includes a first locking face and a second locking face.

Because the first locking face of the pivotal movement restricting part 63 engages with the first locking face of the pivotal movement allowable part 73, the pivotal movement caused by the pivot mechanism 51 matches the pivotal movement of the fingers while a reverse pivotal movement is restricted.

Because the second locking face of the pivotal movement restricting part 63 engages with the second locking face of the pivotal movement allowable part 73, the pivotal movement caused by the pivot mechanism 51 is restricted in a range within a predetermined angle (less than 45-90 degrees, for example, 70 degrees).

The connection retaining mechanism 54 will be described below. While the axis part 61 is inserted into the bearing part 71, the connection retaining groove 64 and the screw hole 74 are positioned corresponding to each other. When the screw hole 74 receives a connection retaining screw 84, a tip end of the connection retaining screw 84 positions in the connection retaining groove 64. The tip end of the connection retaining screw 84 engages with the connection retaining groove 64 to restrict movement thereof in an axis direction, thereby retaining the connection state.

On the other hand, according to the pivotal movement caused by the pivot mechanism 51, the tip end of the connection retaining screw 84 moves in and along the connection retaining groove 64. Accordingly, the connection holding mechanism 54 would not block the pivotal movement.

Referring back to FIG. 1 and FIG. 2, the other structure will be described below.

The handle part 22 of the scissor half ring side part 27 is provided with the finger resting and hooking parts 41, 42. The finger resting and hooking part 41 is formed into a quarter ring 41 and the finger resting and hooking part 42 is formed into a one-eighth ring (one eighth=⅛) 42.

The quarter ring 41 extends from a position between the pivot 3 and the ring finger ring 23 oriented toward the scissor tip end side so as to contact with the back of the index finger. The quarter ring 41 is shaped into a ¼ arch of the elliptical ring finger ring 23. With the structure, the quarter ring 41 opens toward the scissor tip end side.

The one-eighth ring 42 is provided on the ring finger ring 23 oriented toward the scissor tip end side so as to contact with the back of the middle finger. The one-eighth ring 42 has a shape approximately identical to a ⅛ arch of the elliptical ring finger ring 23. Accordingly, the one-eighth ring 42 opens toward the scissor tip end side.

The handle part 22 of the scissor half blade side part 26 is provided with the hit point 29 at a position between the coupling part 25 and the pivot 3.

### Acts and Effects

Effects of the present embodiment will be described below in comparison with the conventional art from the perspective of the basic haircutting operation.

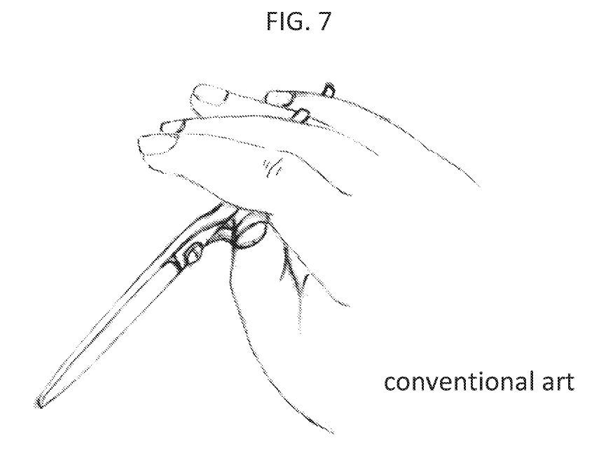

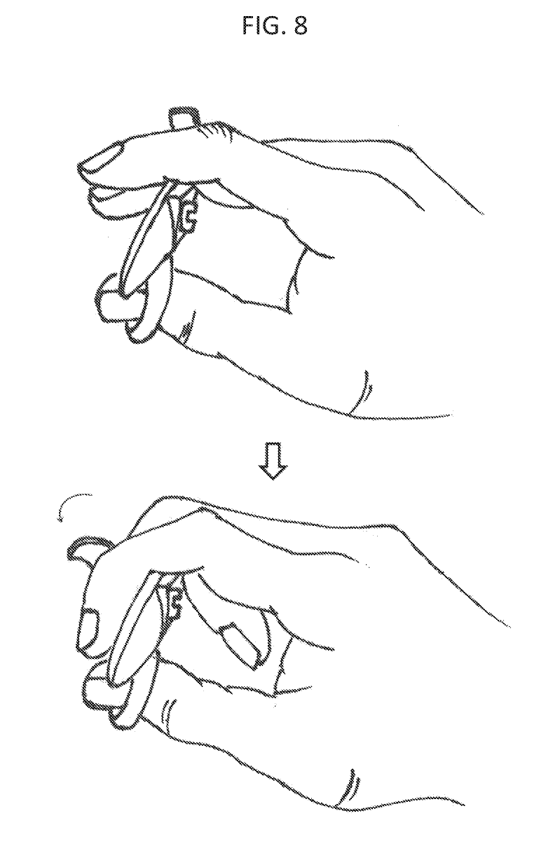

FIG. 6 schematically illustrates scissors of the conventional art. FIG. 7 illustrates a haircutting operation of the conventional art.

A thumb is inserted into a thumb ring, a ring finger is inserted into a ring finger ring, and an index finger and a middle finger serve to support a handle part, and a little finger is hooked on a little-finger rest.

When the thumb is moved in an opening direction, a moving blade pivots with respect to a stationary blade to open the scissors. Further, when a thumb pad side presses the thumb ring, the moving blade pivots in an inverse direction with respect to the stationary blade to close the scissors. At the time, hair positioned between the stationary blade and the moving blade is cut. The opening/closing is repeated.

At the time, because the ring finger and the ring finger ring contact with each other, the attitude of the stationary blade can be held. The four fingers (index finger, middle finger, ring finger, and little finger) are in an opening state. Keeping the attitude requires a movement contrary to the natural movement of man. Thus, other muscles in addition to the muscles of fingers are also suffered from tension.

Further, the movement of the fingers are accorded to traces of two rings. The ring finger is restricted by the ring finger ring and thus a large load generates at the ring contact portion where the ring finger contacts.

Still further, when closing the scissors, the thumb ring and the ring finger ring impact to generate a shock.

The above described operation gives the burden on the hair expert, which may be the cause of the tenosynovitis.

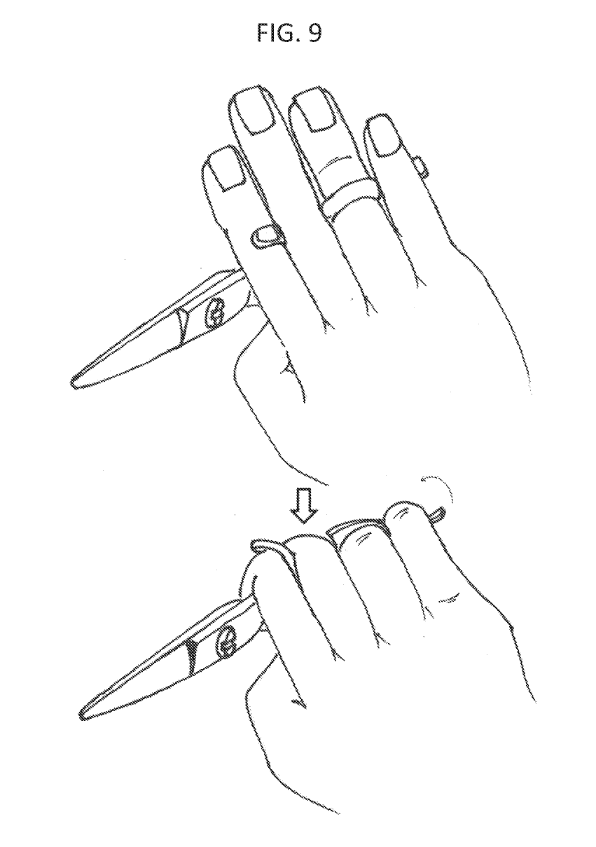

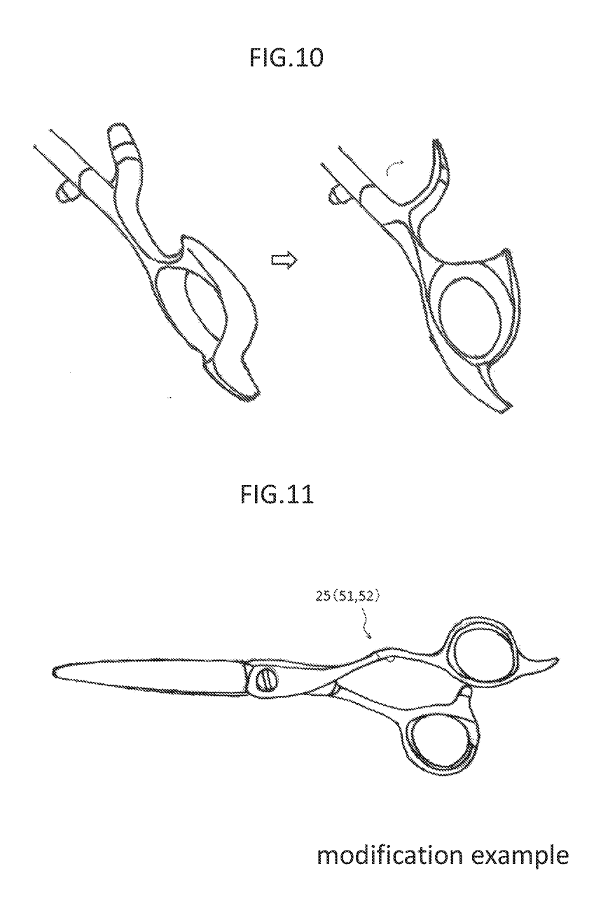

FIG. 8 and FIG. 9 illustrate a haircutting operation of the present embodiment. FIG. 10 illustrates the movement of the present embodiment in detail.

The thumb is inserted into the thumb ring 13, the back of the index finger is brought into contact with the quarter ring 41, the middle finger is brought into contact with the one-eighth ring 42, the ring finger is inserted into the ring finger ring 23, and the little finger is hooked on the little finger hook 24.

The basic haircutting operation is common with that of the conventional art and different from the conventional art in the following points.

When closing the scissors, a load is generated at the ring contact portion where the ring finger contacts. The load makes the scissor half ring side part 27 move pivotably against a force of the torsion spring 82. The load allows rotation (bending state) of the four fingers (index finger, middle finger, ring finger, little finger) according to the pivotal movement of the scissor half ring side part 27. The bending of the four fingers is a natural movement of man and thus an adverse effect to other muscles other than the muscles of the fingers is little.

On the other hand, acting of the opposing force of the torsion spring 82 suppresses the pivotal movement contrary to the intention of the hair expert. Accordingly, the hair expert can get such a sense of unity that the scissors tightly fit to his fingers.

Even when the scissor half ring side part 27 pivotably moves, the attitude of the scissor half blade side part 26, i.e., the stationary blade 21, can be retained.

While the fingers move according to traces of two rings in the conventional art, in the present embodiment, the above described pivotal movement can be controlled by the fingers. With the above described pivotal movement, the ring finger is not restrained by the ring finger ring and thus the stress on the ring finger can be remarkably reduced.

Further, although the handle part 12 impacts the hit point 29 when closing the scissors, the shock is absorbed by the above described pivotal movement.

When opening the scissors, the opposing force of the torsion spring 82 acts as a biasing force. This can reduce a force required in the thumb opening direction.

With the above described movement, the stress on the ring finger can be reduced and the burden on the hairdresser can be suppressed. As a result, the tenosynovitis of the fingers and the wrist can be prevented.

### Other Effects

Recently, a novel cutting technique is developed. The technique requires an unnatural posture such as excessive flex of the wrist. In the present embodiment, the flex of the wrist can be moderated by the rotation of the four fingers. More specifically, the present embodiment is useful for various cutting technique.

Effects obtained from the mechanisms other than the pivot mechanism 51 and the elastic mechanism 52 will be described below.

The present embodiment includes the pivotal movement restricting mechanism 53. With the mechanism, the pivotal movement in a reverse direction and excessive pivotal movement can be suppressed.

The present embodiment includes the connection retaining mechanism 54. The mechanism enables the above described pivotal movement as well as can keep an integrity with the scissor half 2.

The present embodiment includes the quarter ring 41 and the one-eighth ring 42. With the structure, a twisting moment that occurs at the time of pivotal movement can be suppressed and the reaction force of the pivotal movement is dispersed to the four fingers. As a result, the burden on the hairdresser can be reduced.

The present embodiment includes the hit point 29. In the present embodiment, because the pivotal movement as described above absorbs the shock, the hit point is no longer required to be provided between the thumb ring and the ring finger ring. Further, since the hit point 29 is provided on the scissor half blade side part 26, the pivotal movement of the scissor half ring side part 27 is not disturbed thereby. Therefore, the hair expert does not feel unnatural discomfort.

### Modification Example

The present invention is not restricted by the above described embodiment. Various changes can be made without departing from the technical concept of the present invention.

FIG. 11 illustrates a modification example of the present invention. The coupling part 25, the pivot mechanism 51, and the elastic mechanism 52 are added to the conventional scissors (see, FIG. 6).

With the construction, the stress on the ring finger can be reduced and further the burden on the hairdresser can be reduced in a manner as set force in the above described embodiment. As a result, the tenosynovitis of the fingers and the wrist can be prevented.

Other modification examples will be described below.

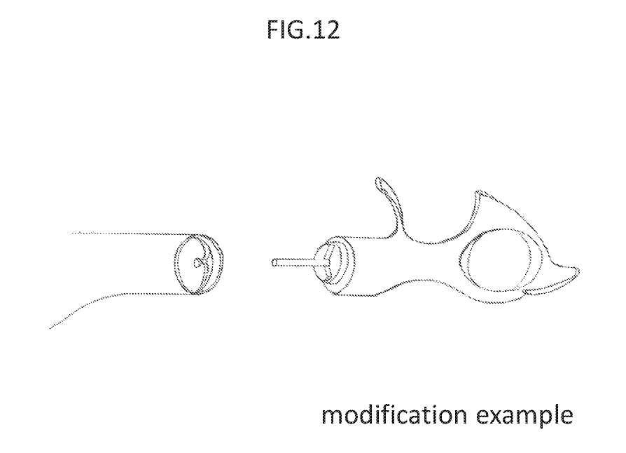

While the axis part 61 and the bearing part 71 are employed as the pivot mechanism 51 in the above described embodiment, the other structure is also employable. For example, the bearing part may be provided on the scissor half blade side part 26, and the axis part may be provided on the scissor half ring side part 27 (see, FIG. 12).

While the torsion spring 82 was employed as the elastic mechanism 52 in the above described embodiment, the other structure is also employable. For example, an elastic body such as power spring, leaf spring, hydro-pneumatic spring, and resin may be employed.

While a locking structure composed of the pivotal movement restricting part 63 and the pivotal movement allowable part 73 was employed as the pivotal movement restricting mechanism 53 in the above described embodiment, the other structure is also employable. For example, such a structure is acceptable that a bearing part is provided on the scissor half blade side part 26 and an axis part is provided on the scissor half ring side part 27, wherein a pivotal movement restricting part is provided on a base of the axis part and a pivotal movement allowable part is provided on the bearing part (see, FIG. 12).

While the connection retaining groove 64, the screw hole 74, and the connection retaining screw 84 are employed as the connection retaining mechanism 54 in the above described embodiment, the other structure is also acceptable if the coupling can be ensured while allowing the pivotal movement.

In the above described embodiment, both the quarter ring 41 and the one-eighth ring 42 are employed as the finger resting and hooking part, but are selectable.

In the above described embodiment, the hit point 29 was provided on the handle part 22 of the scissor half blade side part 26, but may be provided on a position corresponding to the handle part 12.

### REFERENCE CHARACTER LIST

1 scissor half (the first)
2 scissor half (the second)
3 pivot
11 moving blade
12 handle part
13 thumb ring
21 stationary blade
22 handle part
23 ring finger ring
24 little-finger rest
25 coupling part
26 second scissor half blade side part
27 second scissor half ring side part
29 hit point
41 quarter ring (index finger resting and hooking part)
42 one-eighth ring (middle finger resting and hooking part)
51 pivot mechanism
52 elastic mechanism
53 pivotal movement restricting mechanism
54 connection retaining mechanism
61 axis part
62 torsion spring insertion part
63 pivotal movement restricting part
64 connection retaining groove
71 bearing part
72 torsion spring insertion part
73 pivotal movement allowable part
74 screw hole
82 torsion spring
84 connection retaining screw

1. Scissors for hairdressing,
wherein the scissors comprise a first scissor half comprising a blade part and a thumb ring and a second scissor half comprising a blade part and a ring finger ring, the first scissor half and the second scissor half being pivotably coupled together via a pivot;
wherein the second scissor half comprises a second scissor half blade side part and a second scissor half ring side part, the second scissor half blade side part and the second scissor half ring side part being pivotably coupled about a coupling axis via a coupling part to form the second scissor half; and
wherein the coupling part is provided with an elastic mechanism for turning back the pivotal movement.

2. The scissors for hairdressing according to claim 1, wherein the elastic mechanism comprises a torsion spring.

3. The scissors for hairdressing according to claim 1,
wherein the pivotal movement is performed such that the second scissor half blade side part pivots in a rotation direction of four fingers with respect to the second scissor half ring side part; and
wherein the coupling part is provided with a pivotal movement restricting mechanism for restricting the pivotal movement beyond a predetermined angle.

4. The scissors for hairdressing according to claim 1, wherein the coupling part is provided with a connection retaining mechanism for retaining coupling connection while allowing the pivotal movement.

5. The scissors for hairdressing according to claim 1, wherein a finger resting and hooking part for hooking an index finger or/and a middle finger is provided at a position toward a scissor tip end side from the ring finger ring of the second scissor half ring side part.

6. The scissors for hairdressing according to claim 1, wherein a hit point is provided on a position toward a pivot side from the coupling part of a handle part of the first scissor half or the second scissor half.

7. Scissors for hairdressing,
wherein the scissors comprise a first scissor half comprising a blade part and a thumb ring and a second scissor half comprising a blade part and a ring finger ring, the first scissor half and the second scissor half being pivotably coupled via a pivot, the scissors further comprising:
a coupling part for coupling the second scissor half blade side part and the second scissor half ring side part in one piece so as to form the second scissor half;
a pivot mechanism for causing the second scissor half ring side part to pivot about a coupling axis of the coupling part with respect to the second scissor half blade side part; and an elastic mechanism that opposes to the pivotal movement.
